(19) United States
(12) Patent Application Publication
(10) Pub. No.: US 2026/0089087 A1
(43) Pub. Date: Mar. 26, 2026

(54) SYSTEMS AND METHODS FOR NETWORK PATH DISCOVERY

(71) Applicant: Apple Inc., Cupertino, CA (US)

(72) Inventors: Varun Vij, Saratoga, CA (US); Mradul Saxena, Union City, CA (US)

(21) Appl. No.: 18/896,164

(22) Filed: Sep. 25, 2024

(51) Int. Cl. H04L 45/00; H04L 45/122; H04L 45/741

(52) U.S. Cl. CPC H04L 45/20; H04L 45/122; H04L 45/741

(57) ABSTRACT

An electronic device generates a packet and sets a field of the packet equal to a Time to Live (TTL) value. The electronic device may then attempt to transmit the packet to a destination device, but the packet may first be transmitted to a routing device associated with a number of hops on its way to the destination device. The electronic device transmits the packet (e.g., and any other packets concurrently) before receiving a response packet from the routing device. Further, the electronic device receives the response packet, which includes an address of the routing device and a copy of the packet. The electronic device associates the address with the number of hops based on the field in the copy of the packet. That is, by associating the address with the number of hops, the electronic device identifies a hop position of the routing device.

### BACKGROUND

The present disclosure relates generally to wireless communication, and more specifically to network path discovery.

An electronic device may employ an application (e.g., traceroute application) to map a path (e.g., network path) data packets may take from a source to a destination. For example, the electronic device may transmit (e.g., send) a number of packets and track intermediate devices (e.g., routing devices, hops) that the data packets pass through. A data packet of the data packets may include a Time to Live (TTL) value, which may decrement each time the data packet traverses each of the intermediate devices. When the TTL value reaches zero at an intermediate device, the intermediate device may transmit an error message, such as an Internet Control Message Protocol (ICMP) packet, to the electronic device, which indicates that the TTL is expired. The traceroute application may operate sequentially and incrementally increase the TTL value of each packet of the number of packets transmitted.

However, the electronic device may be unable to transmit a subsequent incremented packet until a response, such as the ICMP packet (e.g., for a previous incremented packet) for a previously transmitted packet, is received or declared as lost (e.g., timed out). For example, the electronic device may transmit a first packet to a first routing device, wait for the ICMP packet from the first routing device, and then transmit a second packet to a second routing device. Thus, mapping the network path may be inefficient and increase latency due to having to receive the response packet by the electronic device before transmission of a subsequent packet.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device includes a transmitter, a receiver, and processing circuitry coupled to the transmitter and the receiver, the processing circuitry is configured to generate a first packet having a field including a first number of hops that the first packet is to exist inside a network, and generate second packet having the field including a second number of hops that the second packet is to exist inside the network. The processing circuitry is also configured to transmit, via the transmitter, the first packet to a first routing device associated with the first number of hops at a first time, transmit, via the transmitter, the second packet to a second routing device associated with the second number of hops at the first time, and receive, via the receiver, a first response packet from the first routing device at a second time after the first time, the first response packet including a first address of the first routing device and a copy of the first packet. Further, the processing circuitry is configured to associate the first address with the first number of hops based on the field in the copy of the first packet, receive, via the receiver, a second response packet from the second routing device at a third time, the second response packet including a second address of the second routing device and a copy of the second packet, and associate the second address with the second number of hops based on the field in the copy of the second packet.

In another embodiment, a method includes generating, via processing circuitry, a first packet having a field comprising a first number of hops that the first packet is to exist inside a network, and transmitting, via the processing circuitry, the first packet to a first routing device associated with the first number of hops. The method also includes receiving, via the processing circuitry, a first response packet from the first routing device, the first response packet including a first address of the first routing device and a copy of the first response packet, and associating, via the processing circuitry, the first address with the first number of hops based on the field.

In yet another embodiment, one or more tangible non-transitory computer-readable media store instructions that, when executed by processing circuitry, are configured to cause the processing circuitry to generate a first packet having a field comprising a first number of hops that the first packet is to exist inside a network, and transmit the first packet to a first routing device associated with the first number of hops. The instructions, when executed by the processing circuitry, are also configured to cause the processing circuitry to receive a response packet from the first routing device, the response packet including a first address of the first routing device and a copy of the first packet, and associate the first address with the first number of hops based on the field in the copy of the first packet.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of an electronic device, according to embodiments of the present disclosure;

FIG. 2 is a functional diagram of the electronic device of FIG. 1, according to embodiments of the present disclosure;

FIG. 3 is a schematic diagram of the electronic device of FIG. 1 initiating communication with an additional electronic device, according to embodiments of the present disclosure;

FIG. 4 is a schematic diagram of the electronic device of FIG. 1 concurrently transmitting data packets to the additional electronic device, according to embodiments of the present disclosure;

FIG. 5 is a flow diagram of a process for the electronic device of FIG. 1 to associate an address of a routing device with a hop number by concurrently sending data packets, according to embodiments of the present disclosure; and

FIG. 6 is a flow diagram of a process for the electronic device of FIG. 1 to identify a hop position by concurrently sending data packets, according to embodiments of the present disclosure.

### DETAILED DESCRIPTION OF SPECIFIC EMBODIMENTS

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members.

This disclosure is directed to techniques for discovering network path information of a network. For example, an electronic device (e.g., server device, source device) may employ techniques described herein to map a path (e.g., network path) that one or more data packets may take from the electronic device to an additional electronic device (e.g., destination device). The electronic device may initiate communication with the additional electronic device by transmitting one or more data packets to the additional electronic device using a number of routing devices. For example, each data packet may include a Time to Live (TTL) value, which is associated with a number of hops that the data packet is set to exist inside the network. By setting the TTL value, the electronic device may trigger a response from the routing device, such as transmission of a response packet with a TTL expiration message to the electronic device.

As an example, the electronic device may generate a first packet and set (e.g., assign) a first field (e.g., Internet Protocol (IP) identification (ID) field, flow label field) of the first packet equal to a first TTL value. Moreover, the electronic device may generate a second packet and set a second field of the second packet equal to a second TTL value. The electronic device may set each of the first field and the second field equal to a monotonically (e.g., incrementally) increasing Time to Live (TTL) value, which is associated with a number of hops a packet is to exist inside the network. That is, for the monotonically increasing TTL value, each subsequent packet that the electronic device generates may have a greater (e.g., larger) field value and corresponding TTL value than a previous packet. For example, the electronic device may generate the first packet having the first field equal to the first TTL value of one and the second packet having the second field equal to the second TTL value of two.

The electronic device may transmit the first packet to a first routing device associated with a first number of hops (e.g., first hop number) and the second packet to a second routing device (e.g., via the first routing device) associated with a second number of hops (e.g., second hop number) at a first time. The first routing device may transmit a first response packet to the electronic device at a subsequent period of time (e.g., after the first time), and the second routing device may transmit a second response packet to the electronic device at the subsequent period of time. The first response packet may include a first address of the first routing device and a copy of the first packet (e.g., copy of the first packet headers up until the payload) including the first field received by the first routing device. Further, the second response packet may include a second address of the second routing device and a copy of the second packet (e.g., copy of the second packet headers up until the payload) including the second field received by the second routing device. The electronic device may then receive the first response packet from the first routing device and the second response packet from the second routing device.

The electronic device may associate the first address with the first number of hops based on the first field in the copy of the first packet. For example, the electronic device may extract the first TTL value, which be the same as a first number of hops, from the first field included in the copy of the first packet. Additionally, the electronic device may associate the second address with the second number of hops based on the second field in the copy of the second packet. Indeed, the electronic device may extract the second TTL value, which may be the same as a second number of hops, from the second field included in the copy of the second packet.

For example, the first address may be associated with a number of hops of one (e.g., the first TTL value of one included in the first field) and the second address may be associated with a number of hops of two (e.g., the second TTL value of two included in the second field). Thus, the electronic device may identify the first routing device is in the first hop position, and the second routing device is in the second hop position. In this manner, the electronic device may identify and/or sort the first hop position of the first routing device based on the first field and the second hop position of the second routing device based on the second field. As such, the electronic device may determine (e.g., discover) network path information for the first packet and the second packet. It should be noted that the techniques for discovering network path information described herein may be performed with any suitable number of packets (e.g., 2 or more, 5 or more, 10 or more, and so on).

As such, embodiments described herein may enable the electronic device to transmit the first packet and the second packet at a same or nearly the same time (e.g., concurrently), without having to receive the first response packet from the first routing device before transmitting the second packet to the second routing device. That is, the electronic device may transmit the first packet and the second packet at the same or nearly the same time and identify the first hop position of the first routing device based on the first field (e.g., in the first response packet), and the second hop position of the second routing device based on the second field (e.g., in the second response packet). Therefore, techniques described herein may improve efficiency and reduce latency in the discovery of network path information.

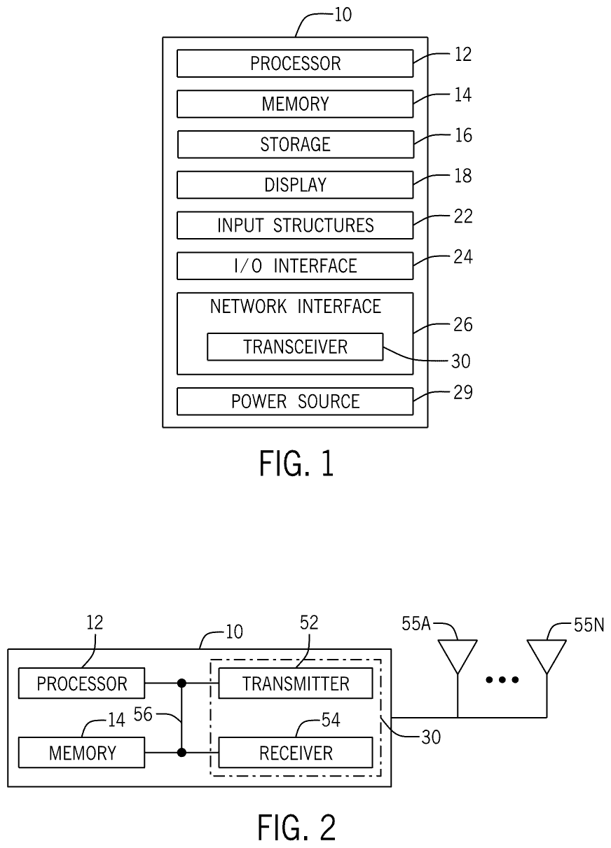

FIG. 1 is a block diagram of an electronic device 10 (e.g., server device, source device), according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device such as a wireless electronic device or smartphone, a tablet, a wearable electronic device, and other similar devices. In additional or alternative embodiments, the electronic device 10 may include an access point, such as a base station, a router (e.g., a wireless or Wi-Fi router), a hub, a switch, and so on. It should be noted that the processor 12 and other related items in FIG. 1 may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. In some embodiments, the I/O interface 24 may include an I/O port for a hardwired connection for charging and/or content manipulation using a standard connector and protocol, such as the Lightning connector, a universal serial bus (USB), or other similar connector and protocol. The network interface 26 may include, for example, one or more interfaces for a personal area network (PAN), such as an ultra-wideband (UWB) or a BLUETOOTH network, a local area network (LAN) or wireless local area network (WLAN), such as a network employing one of the IEEE 802.11x family of protocols (e.g., WI-FI), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, Long Term Evolution (LTE) cellular network, Long Term Evolution License Assisted Access (LTE-LAA) cellular network, 5^{th} generation (5G) cellular network, and/or New Radio (NR) cellular network, a 6^{th} generation (6G) or greater than 6G cellular network, a satellite network, a non-terrestrial network, and so on. In particular, the network interface 26 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 26 of the electronic device 10 may allow communication over the aforementioned networks (e.g., 5G, Wi-Fi, LTE-LAA, and so forth).

The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, ultra-wideband (UWB) network, alternating current (AC) power lines, and so forth.

As illustrated, the network interface 26 may include a transceiver 30. In some embodiments, all or portions of the transceiver 30 may be disposed within the processor 12. The transceiver 30 may support transmission and receipt of various wireless signals via one or more antennas, and thus may include a transmitter and a receiver. The power source 29 of the electronic device 10 may include any suitable source of power, such as a rechargeable lithium polymer (Li-poly) battery and/or an alternating current (AC) power converter.

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55) may be communicatively coupled directly or indirectly (e.g., through or via another component, a communication bus, a network) to one another to transmit and/or receive signals between one another.

The electronic device 10 may include the transmitter 52 and/or the receiver 54 that respectively transmit and receive signals between the electronic device 10 and an external device via, for example, a network (e.g., including base stations, access points, routing devices, and so on) or a direct connection. As illustrated, the transmitter 52 and the receiver 54 may be combined into the transceiver 30. The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement, and so on. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. In some embodiments, the transmitter 52 and the receiver 54 may transmit and receive information via other wired or wireline systems or means.

As illustrated, the various components of the electronic device 10 may be coupled together by a bus system 56. The bus system 56 may include a data bus, for example, as well as a power bus, a control signal bus, and a status signal bus, in addition to the data bus. The components of the electronic device 10 may be coupled together or accept or provide inputs to each other using some other mechanism.

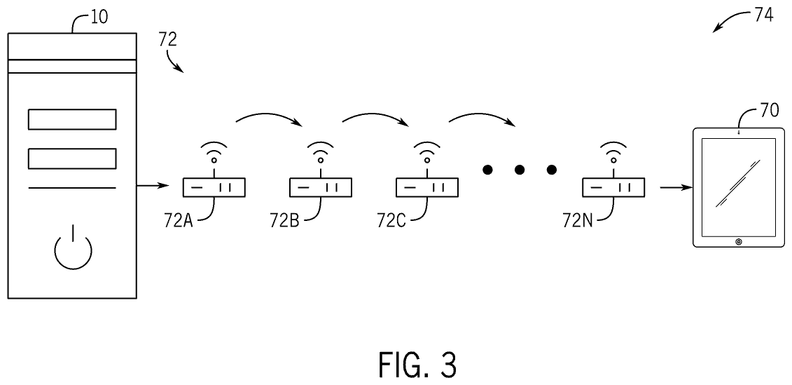

FIG. 3 is a schematic diagram of the electronic device 10 of FIG. 1 initiating communication with an additional electronic device 70 (e.g., destination device). That is, the electronic device 10 may transmit data packets (e.g., one or more data packets) to the additional electronic device 70 using routing devices 72 (e.g., one or more routing devices). The electronic device 10 may initiate communication with the additional electronic device 70 by sending the data packets to the additional electronic device 70. The electronic device 10 may send the data packets through the routing devices 72, which forward the data packets between one another and ultimately to the additional electronic device 70.

In an embodiment, the electronic device 10 may execute (e.g., run, launch) an application (e.g., traceroute application) to map a path the data packets may take from the electronic device 10 to the additional electronic device 70. For example, the electronic device 10 may transmit (e.g., send) the data packets and identify the routing devices 72 (e.g., hops, intermediate devices) that the data packets may pass through to arrive at the additional electronic device 70. It should be noted that a number of hops and/or a number of data packets employed in initiating communication with the additional electronic device 70 may be configurable (e.g., via user input and/or programming of the electronic device 10). In an embodiment, a maximum number of hops may be set and/or equal to any suitable number of hops, such as 1 or more, 2 or more, 8 or more, 12 or more, 64 or more, and so on.

Each data packet of the data packets may include a TTL value, which is associated with a number of hops that the data packet is set to exist inside a network 74. For example, the TTL value may correspond to how long (e.g., how many of the routing devices 72) the data packet may traverse in the network 74 before being discarded. The electronic device 10 may monotonically (e.g., incrementally) increase the TTL value for each data packet (e.g., each successive or subsequent packet) of the data packets. Moreover, each time the data packet passes through a routing device 72 of the routing devices 72, the TTL value may be decremented by one. As an example, the electronic device 10 may transmit a data packet with a TTL value of two. Thus, the electronic device 10 may transmit the data packet to a first routing device 72A of the routing devices 72 and the TTL value may decrement to one. Further, the first routing device 72A may transmit the data packet to the second routing device 72B of the routing devices 72 and the TTL value may decrement to zero.

When the TTL value reaches zero, the data packet is discarded (e.g., by the second routing device 72B). Additionally, the device at which the TTL value reaches zero (e.g., the routing device 72, such as the second routing device 72B), may transmit a response packet to the electronic device 10. The response packet may include an Internet Control Message Protocol (ICMP) packet, which may include a TTL expired message. However, in some cases, the electronic device 10 may be unable to transmit a subsequent data packet until the response packet for the previous data packet is received, which may be inefficient and increase a total duration (e.g., time taken) to discover a network path in the network 74.

Indeed, the electronic device 10 may increase the TTL value of each data packet transmitted sequentially to map the network path, discovering one routing device 72 (e.g., one hop) at a time by using the TTL value in the data packets. If the electronic device 10 were to transmit multiple packets with different TTL values at a same or nearly the same time, the electronic device 10 may be unable to accurately identify the hop positions of the routing devices 72 due to receipt of out-of-order response packets and/or difficulty in associating each response packet with its respective routing device 72. Therefore, the electronic device 10 transmits the data packet and receives the response packet before proceeding to transmission of the next data packet to enable identification of hop positions sequentially as the response packets are received.

Therefore, the electronic device 10 may set a field of each of the data packets equal to the TTL value (e.g., that remains constant, stays fixed, does not decrement) to enable efficient identification of hop positions. For example, the field may include an Internet Protocol (IP) identification (ID) field for Internet Protocol version 4 (IPv4) or a flow label field for Internet Protocol version 6 (IPv6), though any suitable field that may store the TTL value is contemplated. The electronic device 10 may then attempt to transmit the data packets to the additional electronic device 70 using the routing devices 72. However, a respective data packet of the data packets may first be transmitted to a respective routing device 72 of the routing devices 72 on its way to the additional electronic device. Further, due to a TTL value of each of the data packets, the respective data packet may reach a respective routing device 72 of the routing devices 72 (e.g., and not the additional electronic device 70). Indeed, the respective routing device 72 may discard the respective data packet if the TTL value is expired.

The respective routing device 72 may transmit a respective response packet to the electronic device 10, which includes an address of the respective routing device 72 and a copy of the respective data packet (e.g., including the field corresponding to the TTL value). In this manner, the electronic device 10 may identify a hop position of the respective routing device 72 based on the field. For example, the hop positions of the routing devices 72 may be associated with an order of the routing devices 72 on the path that the data packets traverse from the electronic device 10 to the additional electronic device 70.

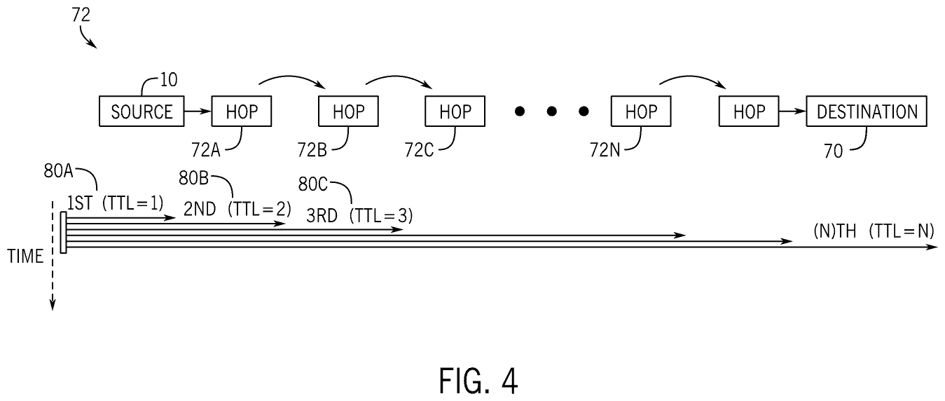

Indeed, FIG. 4 is a schematic diagram of the electronic device 10 of FIG. 1 transmitting the data packets to the additional electronic device 70. As illustrated in FIG. 4, the electronic device 10 may generate a first data packet 80A and set a first field of the first data packet 80A equal to a first TTL value of one. The electronic device 10 may also generate a second data packet 80B and set a second field of the second data packet 80B equal to a second TTL value of two. Additionally, the electronic device 10 may generate a third data packet 80C and set a third field of the third data packet 80C equal to a third TTL value of three. The electronic device 10 may transmit the first data packet 80A with the first field equal to the first TTL value of one to the first routing device 72A. The electronic device 10 may also transmit the second data packet 80B with the second field equal to the second TTL value of two to the second routing device 72B (e.g., passing through the first routing device 72A). Additionally, the electronic device 10 may transmit the third data packet 80C with the third field equal to the third TTL value of three to the third routing device 72C (e.g., passing through the first routing device 72A and the second routing device 72B).

It should be noted that the electronic device 10 may transmit the first data packet, the second data packet, and the third data packet at the same time, concurrently, or within a threshold amount of time of each other (e.g., within 1 millisecond or less, 1 second or less, 5 seconds or less, 10 seconds or less, 60 seconds or less, 120 seconds or less, and so on). Further, it should be noted that the second packet may be transmitted before a first response packet (e.g., from the first routing device 72A) is received for the first packet, and the third packet may be transmitted before a second response packet is received (e.g., from the second routing device 72B) for the second packet (e.g., and before the first response packet is received for the first packet). Moreover, the TTL values that are set in the respective fields of the data packets may not change, increment or decrement, and thus remain constant or fixed.

Thus, as will be described in further detail below, after transmission of the data packets 80A, 80B, 80C, the electronic device 10 may receive the first response packet from the first routing device 72A, which includes a first address of the first routing device 72A and the first field. The electronic device 10 may also receive the second response packet from the second routing device 72B, which includes a second address of the second routing device 72B and the second field. Additionally, the electronic device 10 may receive the third response packet from the third routing device 72C, which includes a third address of the third routing device 72C and the third field. The electronic device 10 may then sort the first address, the second address, and the third address based on the first field, the second field, and the third field. By sorting the first address, the second address, and the third address, the electronic device 10 may efficiently create a map (e.g., discover network path information) of a path or route the data packets take (e.g., using the routing devices 72) to reach the additional electronic device 70.

It should be noted that the electronic device 10 may generate and set a field of any suitable number of data packets to enable efficient creation of the map of the route to the additional electronic device 70. For example, assuming there are n hops or routing devices 72 between the electronic device 10 and the additional electronic device 70, the electronic device 10 may send n data packets, each storing a successively increasing TTL value in its field (e.g., starting at a first data packet having a TTL value of 1 stored in its field), and receive n response packets from the n routing devices 72, where n may be any suitable number of routing device 72, including 1 or more routing devices 72, 2 or more routing devices 72, 5 or more routing devices 72, 7 or more routing devices 72, 10 or more routing devices 72, 12 or more routing devices 72, and so on.

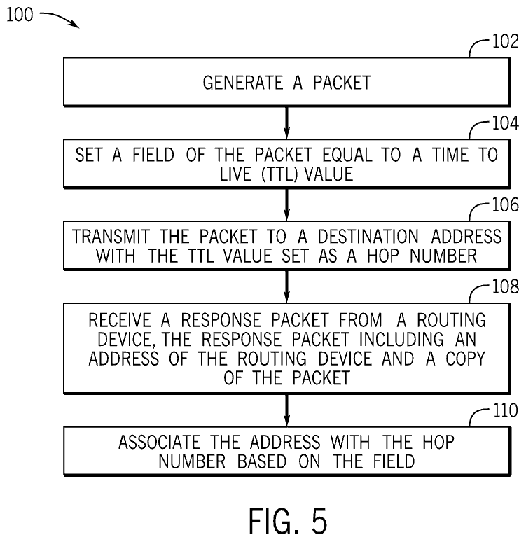

With the foregoing in mind, FIG. 5 is a flow diagram of a process 100 for the electronic device of FIG. 1 to associate a first address with a hop number by concurrently sending (e.g., transmitting) data packets. Any suitable device (e.g., a controller) that may control components of the electronic device 10, such as the processor 12 or the transceiver 30, may perform the process 100. In some embodiments, the process 100 may be implemented by executing instructions stored in a tangible, non-transitory, computer-readable medium, such as the memory 14 or the storage 16, using the processor 12 or the transceiver 30. For example, the process 100 may be performed at least in part by one or more software components such as an operating system of the electronic device 10, one or more software applications of the electronic device 10, and the like. While the process 100 is described using steps in a specific sequence, it should be understood that the present disclosure contemplates that the described steps may be performed in different sequences than the sequence illustrated, and certain described steps may be skipped or not performed altogether.

At process block 102, the processor 12 generates a data packet. For example, as described herein, the data packet may include a 5-tuple, such as a source IP address, a destination IP address, a source port, a destination port, and a protocol (e.g., transport layer protocol being used). Moreover, at process block 104, the processor 12 sets a field of the data packet equal to a TTL value. For example, the processor 12 may set an IP ID field (e.g., in an IP header) of the data packet equal to a TTL value of one. This TTL value that is stored in the field may not change, increment or decrement, and thus remain constant or fixed. At process block 106, the processor 12 transmits the data packet to a destination address (e.g., of the additional electronic device 70) with the TTL value set as a hop number. For example, routing device 72 of the routing devices 72 may be associated with the hop number (e.g., number of hops). In particular, the processor 12 may attempt to transmit the data packet to a destination device (e.g., the additional electronic device 70), but the data packet may first be transmitted to the routing device 72 on its way to the destination device 70.

The hop number may indicate a position of the routing device 72 in a path between a source (e.g., the electronic device 10) and the destination device 70. For example, in FIG. 4, the first routing device 72A may have a hop number of 1, the second routing device 72B may have a hop number of 2, the third routing device 72C may have a hop number of 3, and so on. It should be noted that the processor 12 transmits the data packet to the routing device 72 (e.g., and any subsequent data packets) before receiving a response packet from the routing device 72.

At process block 108, the processor 12 receives the response packet (e.g., the ICMP packet) from the routing device 72, which includes an address of the routing device and a copy of the data packet (e.g., including the field equal to the TTL value). The response packet may indicate to the electronic device 10 that the TTL value of the data packet has expired. Further, the address of the routing device may be included in an IP header of the response packet and the copy of the data packet may be included in a payload (e.g., an ICMP payload) of the response packet.

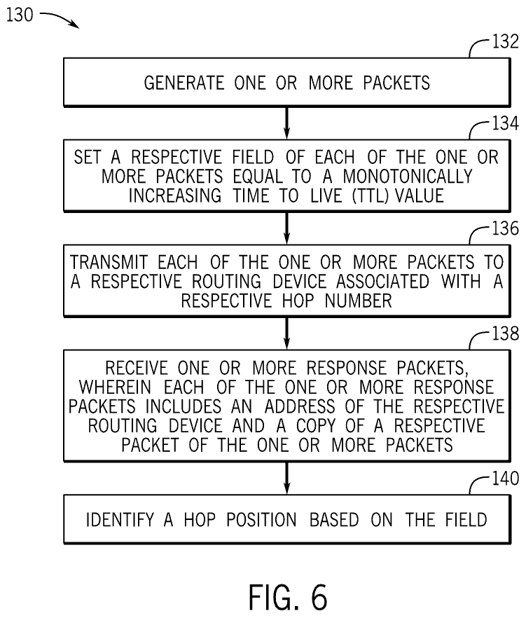

At process block 110, the processor 12 associates the address with the hop number based on the field. Indeed, the processor 12 may extract the TTL value, which may be the same as the hop number, from the field included in the copy of the data packet. The processor 12 may then associate the address with the hop number. In this manner, the processor 12 may identify (e.g., determine) a position (e.g., hop position) of the routing device 72 in the path between the source and the destination based on the field. For example, if the address is associated with a hop number of three (e.g., a TTL value of three in the field), then the electronic device may identify the routing device is in the third hop position in the path. In this manner, the processor 12 may employ the identified positions of the routing devices 72 to build a map of the path taken by the data packets or a list of hops along the path from the source to the destination. Additional details regarding identifying a hop position by concurrently sending data packets via the electronic device 10 will be described below with respect to FIG. 6.

With the foregoing in mind, FIG. 6 is a flow diagram of a process 130 for the electronic device of FIG. 1 to identify a hop position for each of the data packets by concurrently sending data packets. Any suitable device (e.g., a controller) that may control components of the electronic device 10, such as the processor 12 or the transceiver 30, may perform the process 130. In some embodiments, the process 130 may be implemented by executing instructions stored in a tangible, non-transitory, computer-readable medium, such as the memory 14 or the storage 16, using the processor 12 or the transceiver 30. For example, the process 130 may be performed at least in part by one or more software components such as an operating system of the electronic device 10, one or more software applications of the electronic device 10, and the like. While the process 130 is described using steps in a specific sequence, it should be understood that the present disclosure contemplates that the described steps may be performed in different sequences than the sequence illustrated, and certain described steps may be skipped or not performed altogether.

At process block 132, the processor 12 generates one or more data packets. Further, at process block 134, the processor 12 sets a respective field of each of the data packets equal to a monotonically (e.g., incrementally) increasing TTL value. For example, as described herein, the processor 12 may set a first field of a first packet equal to a first TTL value of one. Additionally, the processor 12 may set a second field of a second packet equal to a monotonically higher TTL value of two. The processor 12 may set the respective field of any suitable number of data packets. As such, the processor 12 may set an nth field of a nth packet equal to a TTL value of n. As noted above, the TTL values that are set in the n fields of the n data packets may not change, increment or decrement, and thus remain constant or fixed.

At process block 136, the processor 12 transmits each of the data packets to a respective routing device 72 (e.g., along a path of the network 74) associated with a respective hop number. That is, the processor 12 may attempt to transmit the data packets to a destination device (e.g., the additional electronic device 70), but the data packets may first each be transmitted to a respective routing device 72 on its way to the destination device 70. Further, the processor 12 may transmit each of the data packets concurrently, or at least during a time before any preceding response packets are received from the routing devices 72. Indeed, the processor 12 may transmit each of the data packets before receiving a first response packet.

Moreover, at process block 138, the processor 12 receives one or more response packets, with each of the response packets being transmitted from its respective routing device 72. The response packets may each include an address of the respective routing device 72 and a copy of the data packet (e.g., the data packet originally received by the respective routing device 72). Further, as described herein, the copy of the data packet may include a respective address of the respective routing device 72 and the respective field equal to the TTL value. At process block 140, the processor 12 identifies a hop position (e.g., of each respective routing device 72) based on the field. That is, the processor 12 may extract the TTL value in the respective field included in the copy of the data packet. The respective TTL value may be associated with a number of hops and may be the same as the hop number. Thus, the processor 12 may associate the respective address of the respective with the hop number based on the field. As such, the processor 12 may identify the hop position of each of the routing devices 72 based on extracting the field from the copy of the data packet.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device comprising:
a transmitter;
a receiver; and
processing circuitry coupled to the transmitter and the receiver, the processing circuitry configured to:
generate a first packet having a field comprising a first number of hops that the first packet is to exist inside a network;
generate second packet having the field comprising a second number of hops that the second packet is to exist inside the network;
transmit, via the transmitter, the first packet to a first routing device associated with the first number of hops at a first time;
transmit, via the transmitter, the second packet to a second routing device associated with the second number of hops at the first time;
receive, via the receiver, a first response packet from the first routing device at a second time after the first time, the first response packet comprising a first address of the first routing device and a copy of the first packet;
associate the first address with the first number of hops based on the field in the copy of the first packet;
receive, via the receiver, a second response packet from the second routing device at a third time, the second response packet comprising a second address of the second routing device and a copy of the second packet; and
associate the second address with the second number of hops based on the field in the copy of the second packet.

2. The electronic device of claim 1, wherein the field comprises an Internet Protocol (IP) identification field for IP version 4 or a flow label field for IP version 6.

3. The electronic device of claim 1, wherein the first number of hops and the second number of hops each comprise a Time to Live value.

4. The electronic device of claim 1, wherein the processing circuitry is configured to extract the first number of hops from the field in the copy of the first packet and the second number of hops from the field in the copy of the second packet.

5. The electronic device of claim 1, wherein the first response packet and the second response packet each comprises an Internet Control Message Protocol (ICMP) packet.

6. The electronic device of claim 5, wherein the ICMP packet comprises a message indicating a Time to Live value is expired.

7. The electronic device of claim 1, wherein a header of the first response packet comprises the first address and a header of the second response packet comprises the second address.

8. The electronic device of claim 1, wherein the first address and the second address each comprises an Internet Protocol address.

9. The electronic device of claim 1, wherein the first packet and the second packet each comprises a source Internet Protocol (IP) address, a destination IP address, a source port, a destination port, and a protocol.

10. The electronic device of claim 1, wherein the processing circuitry is configured to sort the first packet and the second packet based on the first number of hops and the second number of hops.

11. The electronic device of claim 1, wherein the copy of the first packet is stored within a payload of the first response packet and the copy of the second packet is stored within the payload of the second response packet.

12. A method comprising:
generating, via processing circuitry, a first packet having a field comprising a first number of hops that the first packet is to exist inside a network;
transmitting, via the processing circuitry, the first packet to a first routing device associated with the first number of hops;
receiving, via the processing circuitry, a first response packet from the first routing device, the first response packet comprising a first address of the first routing device and a copy of the first response packet; and
associating, via the processing circuitry, the first address with the first number of hops based on the field.

13. The method of claim 12, wherein the field comprises an Internet Protocol (IP) identification field for IP version 4 or a flow label for IP version 6.

14. The method of claim 12, wherein the first number of hops comprises a Time to Live value.

15. The method of claim 12, comprising:
generating, via the processing circuitry, a second packet having the field comprising a second number of hops that the second packet is to exist inside the network; and
transmitting, via the processing circuitry, the second packet to a second routing device associated with the second number of hops.

16. The method of claim 15, wherein receiving, via the processing circuitry, the first response packet occurs after transmitting, via the processing circuitry, the second packet.

17. One or more tangible, non-transitory computer-readable media storing instructions that, when executed by processing circuitry, are configured to cause the processing circuitry to:
generate a first packet having a field comprising a first number of hops that the first packet is to exist inside a network;
transmit the first packet to a first routing device associated with the first number of hops;
receive a response packet from the first routing device, the response packet comprising a first address of the first routing device and a copy of the first packet; and
associate the first address with the first number of hops based on the field in the copy of the first packet.

18. The one or more tangible, non-transitory computer-readable media of claim 17, wherein the instructions, when executed by the processing circuitry, are configured to cause the processing circuitry to extract the field from the copy of the first packet.

19. The one or more tangible, non-transitory computer-readable media of claim 17, wherein the instructions, when executed by the processing circuitry, are configured to cause the processing circuitry to:
generate a second packet having the field comprising a second number of hops that the second packet is to exist inside the network; and
transmit the second packet to a second routing device associated with the second number of hops.

20. The one or more tangible, non-transitory computer-readable media of claim 19, wherein the instructions, when executed by the processing circuitry, are configured to cause the processing circuitry to transmit the second packet before receiving the response packet.
